(19) United States
(12) Patent Application Publication
(10) Pub. No.: US 2020/0312351 A1
(43) Pub. Date: Oct. 1, 2020

(54) INFORMATION PROCESSING APPARATUS, INFORMATION PROCESSING METHOD, AND SPEECH EMOTION RECOGNITION SYSTEM

(71) Applicant: TOSHIBA TEC KABUSHIKI KAISHA, Tokyo (JP)

(72) Inventor: Akira TAKAHASHI, Yokohama Kanagawa (JP)

(21) Appl. No.: 16/687,091

(22) Filed: Nov. 18, 2019

(30) Foreign Application Priority Data
Mar. 26, 2019 (JP) 2019-059073

(51) Int. Cl. G10L 25/63; G06F 3/16; G06F 3/01; G06F 9/54; G06F 3/0482

(52) U.S. Cl. CPC G10L 25/63; G06F 3/167; G06F 2203/011; G06F 9/542; G06F 3/0482; G06F 3/011

(57) ABSTRACT

According to an embodiment, an information processing apparatus includes an input device, an output device, and a controller. The controller estimates, when the input device accepts an instruction speech for instructing an operation from a speaker, an emotional state of the speaker on a basis of the instruction speech. The controller then causes the output device to output the estimated emotional state.

### CROSS-REFERENCE TO RELATED APPLICATIONS

This application is based upon and claims the benefit of priority from the prior Japanese Patent Application No. 2019-059073, filed on Mar. 26, 2019, the entire contents of which are incorporated herein by reference.

### FIELD

An embodiment to be described here generally relates to an information processing apparatus, an information processing method, and a speech emotion recognition system.

### BACKGROUND

A point of sales (POS) terminal has been installed in a retail stores, such as a supermarket, previously. A maintenance person for the POS terminal goes to a retail store and performs maintenance work when a failure occurs in the POS terminal or to perform a periodic inspection or the like on the POS terminal. In general, the maintenance person needs to perform maintenance work within the business hours of the retail store.

In such a case, the maintenance person needs to complete the maintenance work in a short time, and thus might feel nervous and pressure to complete the task(s). The maintenance person tends to make more mistakes in the case where he/she feels nervous and pressure.

In a known, existing apparatus, there is an apparatus that employs a technology capable of determining emotions by speech. Such an existing apparatus uses a technology capable of determining emotions by speech to make it possible to recognize that the emotional state of a maintenance person is deteriorating.

Therefore, the maintenance person or another person, such as an administrator of the maintenance person, is capable of taking measures against the deterioration of the emotional state of the maintenance person. However, since the maintenance person is typically in a hurry to perform maintenance work, it is difficult for him/her to input a speech to the above-mentioned existing apparatus for the purpose of only causing the existing apparatus to determine emotional state.

### BRIEF DESCRIPTION OF THE DRAWINGS

FIG. 1 is an explanatory diagram illustrating an example of a maintenance support system according to an embodiment.

FIG. 2 is a block diagram illustrating an example of a hardware configuration of a maintenance person terminal according to the embodiment.

FIG. 3 is a block diagram illustrating an example of a hardware configuration of a management server according to the embodiment.

FIG. 4 is a block diagram illustrating an example of a hardware configuration of an administrator terminal according to the embodiment.

FIG. 5 is a block diagram illustrating an example of a functional configuration of various apparatuses in the maintenance support system according to the embodiment.

FIG. 6 is an explanatory diagram illustrating an example of a work-specific-emotion-statistics list screen according to the embodiment.

FIG. 7 is an explanatory diagram illustrating an example of an emotion-statistics-detail screen according to the embodiment.

FIG. 8 is an explanatory diagram illustrating an example of a maintenance-work-situation list screen according to the embodiment.

FIG. 9 is an explanatory diagram illustrating an example of a notification screen according to the embodiment.

FIG. 10 is a flowchart illustrating an example of state monitoring processing to be executed by the maintenance person terminal according to the embodiment.

FIG. 11 is a flowchart illustrating an example of statistics display processing to be executed by the maintenance person terminal according to the embodiment.

### DETAILED DESCRIPTION

In accordance with one embodiment, an information processing apparatus includes an input device, an output device, and a controller. The input device accepts an input of an instruction speech for instructing an operation from a speaker (person uttering the instruction speech). The output device then outputs an estimated emotional state of the speaker that has been estimated based on the instruction speech. The controller estimates the emotional state of the speaker on a basis of the instruction speech received from the speaker. The controller causes the output device to output the estimated emotional state.

Hereinafter, an embodiment of an information processing apparatus, an information processing method, a program, and a speech emotion recognition system will be described in detail with reference to the drawings. In the drawings, the same reference symbols indicate the same or similar components. Note that the embodiment described below is an embodiment of an information processing apparatus, an information processing method, a program, and a speech emotion recognition system, and does not limit the configuration, specifications, and the like. The information processing apparatus, information processing method, program, and speech emotion recognition system according to this embodiment are examples applied to a maintenance person terminal in a maintenance support system that supports maintenance work of a POS terminal.

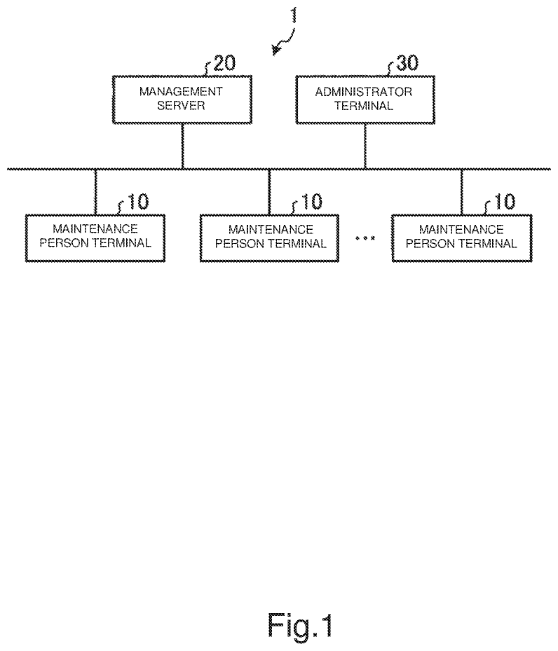

FIG. 1 is an explanatory diagram illustrating an example of a maintenance support system 1 according to an embodiment. The maintenance support system 1 is a system that supports maintenance work of a POS terminal. Further, the maintenance support system 1 is also a speech emotion recognition system that recognizes emotions of a maintenance person by a speech uttered by the maintenance person. The maintenance support system 1 includes a plurality of maintenance person terminals 10, a management server 20, and an administrator terminal 30. The maintenance person terminals 10, the management server 20, and the administrator terminal 30 are communicably connected to each other via a network such as the Internet and a virtual private network (VPN). Note that the maintenance support system 1 shown in FIG. 1 includes one management server 20 and one administrator terminal 30. However, the maintenance support system 1 may include a plurality of management servers 20 and a plurality of administrator terminals 30.

The maintenance person terminals 10 are each a portable information processing apparatus such as a tablet terminal and a smartphone carried by the maintenance person. The maintenance person terminal 10 accepts, as an operation by the maintenance person, an instruction speech uttered by the maintenance person. Then, the maintenance person terminal 10 executes processing instructed by the instruction speech. For example, the maintenance person terminal 10 executes processing of recording content of the work identified by the instruction speech, processing of displaying the operation for explaining the content of work identified by the instruction speech, and the like. Further, the maintenance person terminal 10 estimates the emotional state of the maintenance person that has uttered the instruction speech. Then, the maintenance person terminal 10 outputs the estimation result. For example, the maintenance person terminal 10 notifies, in the case where the maintenance person terminal 10 determines that the emotional state of the maintenance person is abnormal, the administrator terminal 30 or the like of the fact.

The management server 20 is a server apparatus that manages the maintenance support system 1. For example, the management server 20 receives, from the maintenance person terminal 10, situation information indicating the situation of the maintenance person. Further, the management server 20 displays a list indicating the situation of each maintenance person.

The administrator terminal 30 is a portable terminal such as a tablet terminal and a smartphone carried by an administrator. For example, the administrator terminal 30 receives, in the case where it is determined that the emotional state of the maintenance person who operates the maintenance person terminal 10 is abnormal, notification information indicating that the emotional state of the maintenance person is abnormal. Then, the administrator terminal 30 displays a screen indicating that the emotional state of the maintenance person is abnormal.

Next, a hardware configuration of various apparatuses in the maintenance support system 1 will be described.

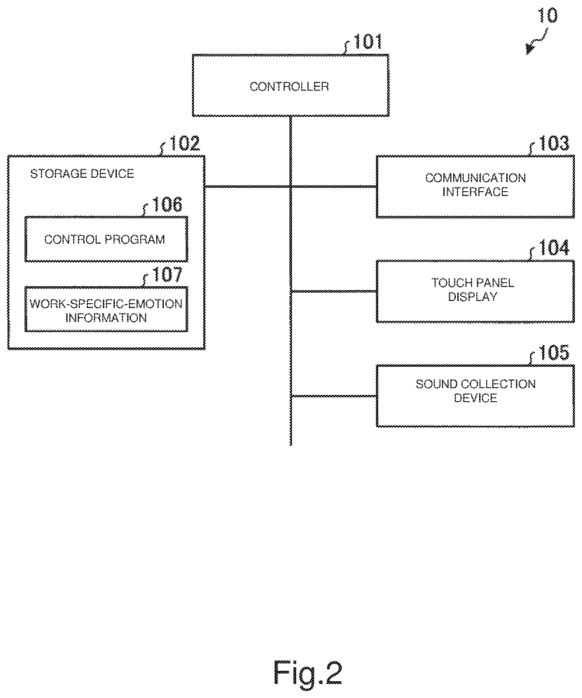

FIG. 2 is a block diagram illustrating an example of a hardware configuration of the maintenance person terminal 10. The maintenance person terminal 10 includes a controller 101, a storage device 102, a communication interface 103, a touch panel display 104, and a sound collection device 105. The respective units 101 to 105 are connected to each other via a system bus such as a data bus and an address bus.

The controller 101 is a computer that controls the operation of the entire maintenance person terminal 10 and realizes various functions of the maintenance person terminal 10. The controller 101 includes a central processing unit (CPU), a read only memory (ROM), and a random access memory (RAM). The CPU integrally controls the operation of the maintenance person terminal 10. The ROM stores various programs and data. The RAM temporarily stores various programs and various types of data. The CPU uses the RAM as a work area, and executes the program stored in the ROM, the storage device 102, or the like.

The storage device 102 is a storage device such as a flash memory. The storage device 102 stores a control program 106 and a work-specific-emotion information 107.

The control program 106 is an operating system, and is a program for realizing the functions of the maintenance person terminal 10. The control program 106 includes a program that realizes the characteristic function according to this embodiment.

The work-specific-emotion information 107 is information indicating the emotional state of the maintenance person for each work performed by the maintenance person. Specifically, the work-specific-emotion information 107 is information in which work information indicating work identified by an instruction speech and emotion information indicating the emotional state are associated with each other.

The communication interface 103 is an output device that outputs the emotional state of a speaker (maintenance person) estimated by the controller 101. The communication interface 103 communicates with another apparatus via, for example, a network.

The touch panel display 104 is, for example, a display device in which a touch panel is stacked on a display screen. The touch panel display 104 detects a touch-operated portion, and determines that an operation corresponding to the display element displayed on the touch panel display 104 has been input.

The sound collection device 105 is an input device that accepts an input of an instruction speech for instructing the operation by the speaker. The sound collection device 105 is, for example, a microphone that collects the voice of the speaker.

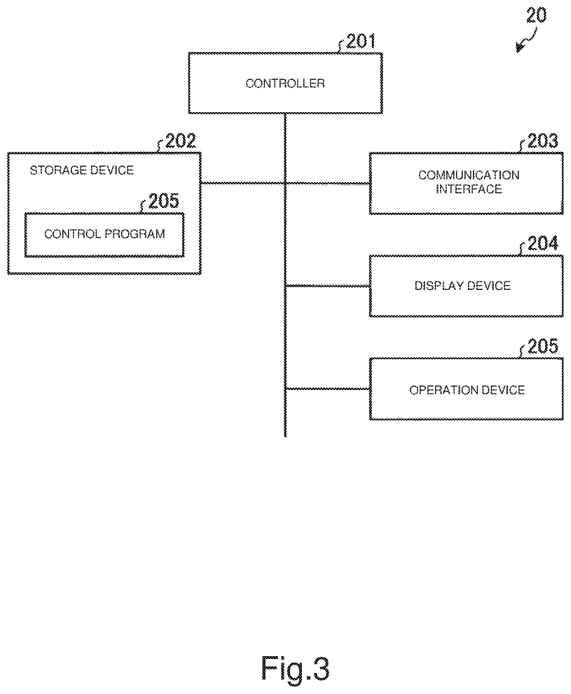

FIG. 3 is a block diagram illustrating an example of a hardware configuration of the management server 20. The management server 20 includes a controller 201, a storage device 202, a communication interface 203, a display device 204, and an operation device 205. The respective units 201 to 205 are connected to each other via a system bus such as a data bus and an address bus.

The controller 201 is a computer that controls the operation of the entire management server 20 and realizes various functions of the management server 20. The controller 201 includes a CPU, a ROM, and a RAM. The CPU integrally controls the operation of the management server 20. The ROM stores various programs and data. The RAM temporarily stores various programs and various types of data. The CPU uses the RAM as a work area, and executes the program stored in the ROM, the storage device 202, or the like.

The storage device 202 includes a hard disk drive (HDD), a solid state drive (SSD), or the like. The storage device 202 stores a control program 206.

The control program 206 is an operating system, and includes a program for exhibiting the functions of the management server 20. The control program 206 includes a program that realizes the characteristic function according to this embodiment.

The communication interface 203 is an interface for communication with another apparatus via a network.

The display device 204 is, for example, a display such as a liquid crystal display. The operation device 205 is, for example, an input device such as a keyboard and a mouse.

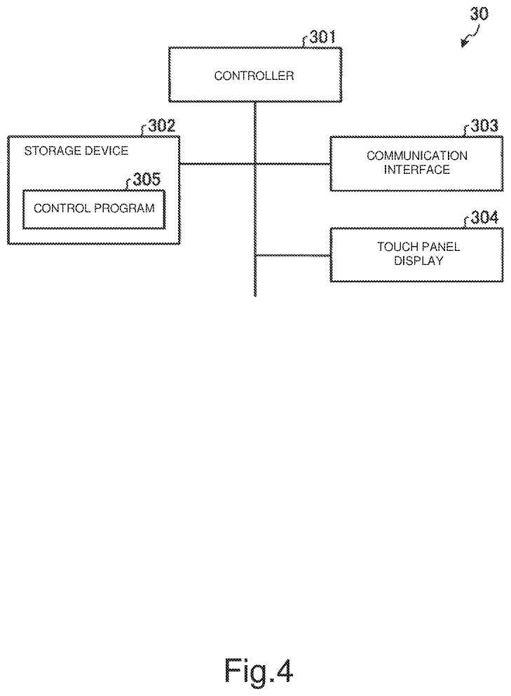

FIG. 4 is a block diagram illustrating an example of a hardware configuration of the administrator terminal 30. The administrator terminal 30 includes a controller 301, a storage device 302, a communication interface 303, and a touch panel display 304. The respective units 301 to 304 are connected to each other via a system bus such as a data bus and an address bus.

The controller 301 is a computer that controls the operation of the entire administrator terminal 30 and realizes various functions of the administrator terminal 30. The controller 301 includes a CPU, a ROM, and a RAM. The CPU integrally controls the operation of the administrator terminal 30. The ROM stores various programs and data. The RAM temporarily stores various programs and various types of data. The CPU uses the RAM as a work area, and executes the program stored in the ROM, the storage device 302, or the like.

The storage device 302 includes a storage device such as a flash memory. The storage device 302 stores a control program 306.

The control program 306 is an operating system, and is a program for exhibiting the functions of the administrator terminal 30. The control program 306 includes a program that exhibits the characteristic function according to this embodiment.

The communication interface 303 is an interface for communicating with another apparatus via a network.

The touch panel display 304 is, for example, a display in which a touch panel is stacked on a display screen. The touch panel display 304 detects a touch-operated portion, and determines that an operation corresponding to the display element displayed on the touch panel display 304 has been input.

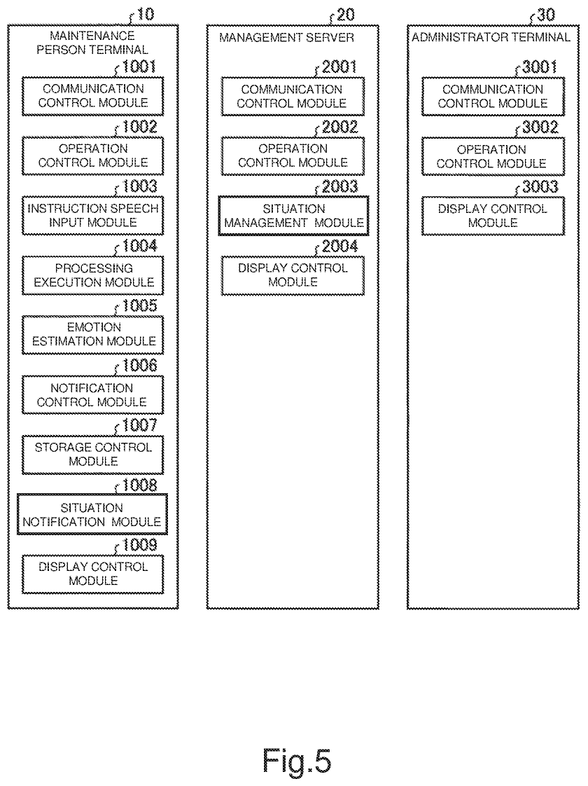

Next, the characteristic function of various apparatuses in the maintenance support system 1 will be described. FIG. 5 is a block diagram illustrating an example of a characteristic functional configuration of various apparatuses in the maintenance support system 1.

The controller 101 of the maintenance person terminal 10 loads the control program 106 of the storage device 102 into the RAM, and operates in accordance with the control program 106, thereby generating functional modules shown in FIG. 5 on the RAM. Specifically, the controller 101 of the maintenance person terminal 10 includes, as functional modules, a communication control module 1001, an operation control module 1002, an instruction speech input module 1003, a processing execution module 1004, an emotion estimation module 1005, a notification control module 1006, a storage control module 1007, a situation notification module 1008, and a display control module 1009.

The communication control module 1001 controls the communication interface 103 to execute communication with the management server 20 and the administrator terminal 30 connected to the network.

The operation control module 1002 controls the touch panel display 104 to accept various operations.

The instruction speech input module 1003 accepts an input of an instruction speech that instructs an operation. In more detail, the instruction speech input module 1003 controls the sound collection device 105 to accept an input of an instruction speech that instructs an operation on the maintenance person terminal 10.

The processing execution module 1004 executes processing instructed by the instruction speech that has been accepted by the instruction speech input module 1003. For example, the processing execution module 1004 executes processing of recording content of the work identified by the instruction speech, processing of displaying the operation for explaining the content of the work identified by the instruction speech, and the like.

The emotion estimation module 1005 estimates the emotional state of the speaker (maintenance person) who has uttered the instruction speech that has been accepted by the instruction speech input module 1003. In more detail, the emotion estimation module 1005 uses a known technology to calculate an emotion value obtained by digitizing emotions of the speaker. For example, the emotion value indicates that the speaker is in a calm state in the case where the value is low. Further, the emotion value indicates that the speaker is in an excited state as the value increases. In other words, the emotion value indicates that the speaker is likely to make mistakes as the value increases.

Further, the emotion estimation module 1005 determines, in the case where the emotion value is not less than a predetermined threshold value, that the speaker is in an abnormal state. Meanwhile, the emotion estimation module 1005 determines, in the case where the emotion value is less than the predetermined threshold value, that the speaker is in a normal state. Note that the level of the emotional state is not limited to the two levels, i.e., the abnormal state and the normal state, and the emotion estimation module 1005 may classify the emotional state of the speaker into three or more levels and determine the emotional state of the speaker. Further, the predetermined threshold value may be a set value settable to an arbitrary value.

The notification control module 1006 performs, on the basis of the emotional state of the speaker estimated by the emotion estimation module 1005, the notification under that condition that the speaker has been determined to be in an abnormal state. In more detail, the notification control module 1006 notifies, in the case where the emotion estimation module 1005 has determined that the speaker is in an abnormal state, that it is necessary to take measures against mistakes.

For example, the notification control module 1006 transmits notification information to the administrator terminal 30. The notification information includes maintenance person information, work place information, work progress information, and message information. The maintenance person information is identification information capable of identifying a maintenance person, such as a maintenance person code. In other words, the maintenance person information is information that identifies a speaker (maintenance person) in an abnormal state. The work place information is information indicating the work place of the maintenance person. The work progress information is information indicating the progress rate of each step in the content of the work performed by the maintenance person. The message information is information indicating a message for an administrator.

The storage control module 1007 stores, in the storage device 102, the work-specific-emotion information 107 in which the work information indicating the work identified by the instruction speech and the emotion information indicating the emotional state are associated with each other. Note that the work information may be, for example, a work code capable of identifying content of the work or a word indicating content of the work. Further, the emotion information is, for example, an emotion value obtained by digitizing the emotional state. Further, the storage control module 1007 stores, in the storage device 102, the work-specific-emotion information 107 every time an instruction speech is input in a series of work. In other words, the storage control module 1007 stores the work-specific-emotion information 107 for each work step in the storage device 102.

The situation notification module 1008 notifies the management server 20 of the situation information indicating the work situation of the maintenance person. In more detail, the situation notification module 1008 causes the communication control module 1001 to transmit the situation information. Note that the situation information includes maintenance person information, work place information, work content information, maintenance person state information, and work progress information. The maintenance person information is identification information capable of identifying a maintenance person, such as a maintenance person code. The work place information is information indicating the work place of the maintenance person. The work content information is information indicating the content of work performed by the maintenance person. Further, the work content information may include information indicating which step of the work content. The maintenance person state information is information indicating the emotional state of the maintenance person who is performing the work. The work progress information is information indicating the progress rate of the content of work performed by the maintenance person.

The display control module 1009 controls the touch panel display 104 to display various screens. For example, the display control module 1009 displays, on the touch panel display 104, a screen relating to processing to be executed by the processing execution module 1004.

Further, the display control module 1009 displays, on the basis of the work-specific-emotion information 107 stored in the storage device 102, a work-specific-emotion-statistics list screen G1 on the touch panel display 104. The work-specific-emotion-statistics list screen G1 indicates work in which the number of times that the speaker is determined to be in an abnormal state is equal to or greater than a predetermined threshold value, of the work performed by the speaker (maintenance person).

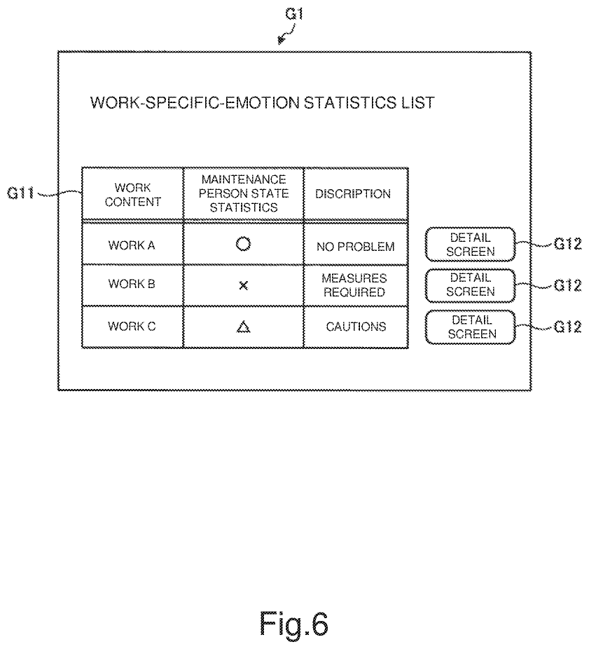

FIG. 6 is an explanatory diagram illustrating an example of the work-specific-emotion-statistics list screen G1. The work-specific-emotion-statistics list screen G1 includes a work-specific-emotion-statistics list G11 and detail screen buttons G12 for each work. The work-specific-emotion-statistics list G11 is a list in which maintenance person state statistics (statistics of the emotional state of the maintenance person) and description are shown for each of pieces of content of the work. The work content represents information indicating the work. Note that the work is work identified by the instruction speech of the speaker. The maintenance person state statistics represent information indicating statistics of the emotional state of the maintenance person who has performed the work. Note that the maintenance person who has performed the work is a maintenance person that the sound collection device 105 has accepted an input of the instruction speech.

For example, the display control module 1009 displays, on the work-specific-emotion-statistics list screen G1, the maintenance person state statistics in three levels in accordance with the number of times of the abnormal state of the maintenance person. The display control module 1009 displays, in the case where the number of times of the abnormal state is less than a first set value, a mark on the work-specific-emotion-statistics list screen G1. The mark indicates that there is no problem with the emotional state of the maintenance person. For example, the display control module 1009 displays a circle mark as the mark indicating that there is no problem with the emotional state of the maintenance person. Further, the display control module 1009 displays, in the case where the number of times of the abnormal state is not less than a second set value larger than the first set value, a mark on the work-specific-emotion-statistics list screen G1 of the touch panel display 104. The mark indicates that it is necessary to take measures against the emotional state of the maintenance person. For example, the display control module 1009 displays an x mark as the mark indicating that it is necessary to take measures against the emotional state of the maintenance person. Further, the display control module 1009 displays, in the case where the number of times of the abnormal state is not less than the first set value and less than the second set value, a mark on the work-specific-emotion-statistics list screen G1. The mark indicates that there is a possibility that it is necessary to take measures against the emotional state of the maintenance person. For example, the display control module 1009 displays a triangle mark as the mark indicating that there is a possibility that it is necessary to take measures against the emotional state of the maintenance person. The description is description of the maintenance person state statistics. Specifically, the display control module 1009 displays, on the basis of the maintenance person state statistics, any of “No problem”, “Measures required”, and “Cautions” on the work-specific-emotion-statistics list screen G1. The detail screen buttons G12 are displayed at positions corresponding to respective works A, B, and C on the work-specific-emotion-statistics list screen G1. The detail screen buttons G12 are each a button that displays an emotion-statistics-detail screen G2 indicating details of statistics of the emotional state of the maintenance person for the work A, B, or C.

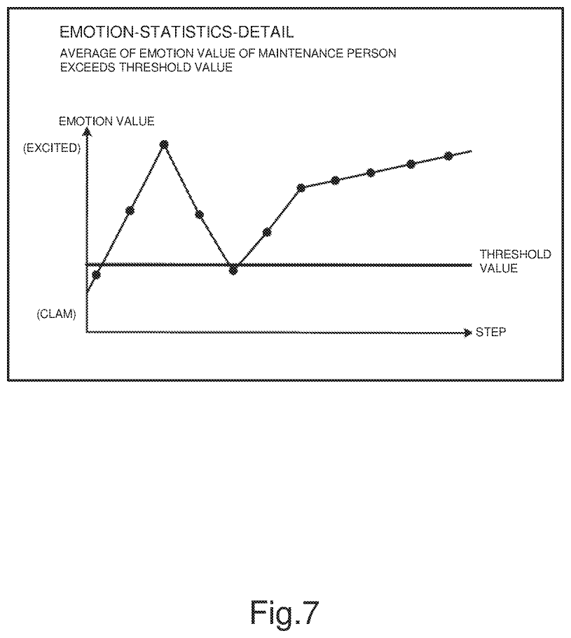

FIG. 7 is an explanatory diagram illustrating an example of the emotion-statistics-detail screen G2. The emotion-statistics-detail screen G2 is a screen that represents, as a graph, the transition of the emotion value of the maintenance person who is performing work. The display control module 1009 extracts the work-specific-emotion information 107 of the work associated with the detail screen button G12, of the pieces of work-specific-emotion information 107 stored in the storage device 102. Further, the display control module 1009 calculates the average value of emotion values for each work step. Then, the display control module 1009 plots the average value for each work step to generate a graph. Note that in the graph shown in FIG. 7, the vertical axis indicates each work step and the horizontal axis indicates the emotion value.

Now, FIG. 5 will be described again. The controller 201 of the management server 20 loads the control program 206 of the storage device 202 into the RAM and operates in accordance with the control program 206, thereby generating functional modules shown in FIG. 5 on the RAM. Specifically, the controller 201 of the management server 20 includes, as functional modules, a communication control module 2001, an operation control module 2002, a situation management module 2003, and a display control module 2004.

The communication control module 2001 controls the communication interface 203 to execute communication with the maintenance person terminal 10 and the administrator terminal 30 connected to the network.

The operation control module 2002 controls the operation device 205 to accept various operations.

The situation management module 2003 manages situation information. In more detail, the situation management module 2003 stores, in the case where the communication control module 2001 receives situation information from the maintenance person terminal 10, the received situation information in the storage device 202.

The display control module 2004 controls the display device 204 to display various screens. For example, the display control module 2004 displays, on the basis of the situation information stored in the storage device 202, a maintenance-work-situation list screen G3 in the display device 204.

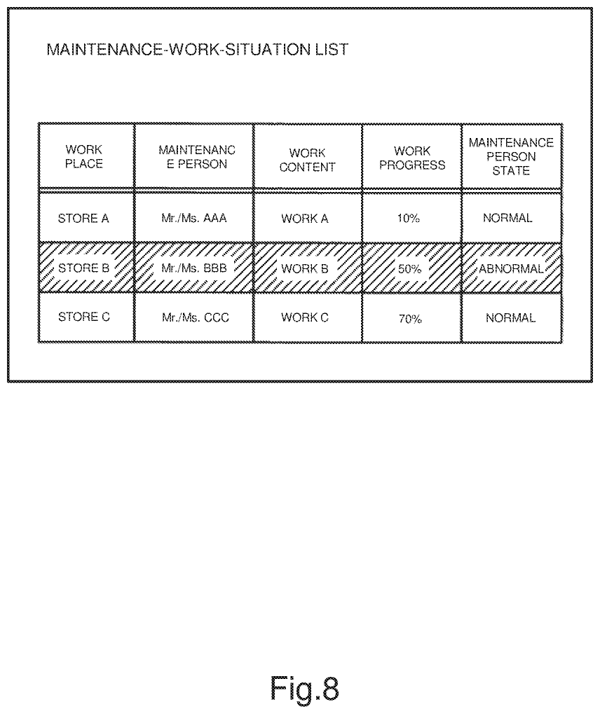

FIG. 8 is an explanatory diagram illustrating an example of the maintenance-work-situation list screen G3. The maintenance-work-situation list screen G3 is a screen indicating a list of work situations of the maintenance person. The maintenance-work-situation list screen G3 includes a work place, a maintenance person, work content, work progress, and a maintenance person state. The work place represents information indicating the place where the work is performed. The maintenance person represents information indicating the maintenance person who is performing the work. The work content represents information indicating the work content performed by the maintenance person. Further, the work content may include information indicating which step of the work content. The work progress represents information indicating the progress rate of each step in the content of the work performed by the maintenance person. The maintenance person state represents information indicting the emotional state of the maintenance person who is performing the work.

In such a maintenance-work-situation list screen G3, the display control module 2004 highlights a maintenance person in an abnormal emotional state, i.e., a maintenance person who is likely to make mistakes. FIG. 8 shows that “Mr./Ms. BBB” is in an abnormally state and is likely to make mistakes. The display control module 2004 highlights the maintenance work situation of “Mr./Ms. BBB” to notify that “Mr./Ms. BBB” is in a state of being likely to make mistakes.

Now, FIG. 5 will be described again. The controller 301 of the administrator terminal 30 loads the control program 306 of the storage device 302 into the RAM and operates in accordance with the control program 306, thereby generating functional modules shown in FIG. 5 on the RAM. Specifically, the controller 301 of the administrator terminal 30 includes, as functional modules, a communication module 3001, an operation control module 3002, and a display control module 3003.

The communication module 3001 controls the communication interface 303 to execute communication with the maintenance person terminal 10 and the management server 20 connected to the network.

The operation control module 3002 controls the touch panel display 304 to accept various operations.

The display control module 3003 controls the touch panel display 304 to display various screens. For example, the display control module 3003 displays, in the case where the communication module 3001 receives notification information from the maintenance person terminal 10, a notification screen G4 on the touch panel display 304 on the basis of the received notification information.

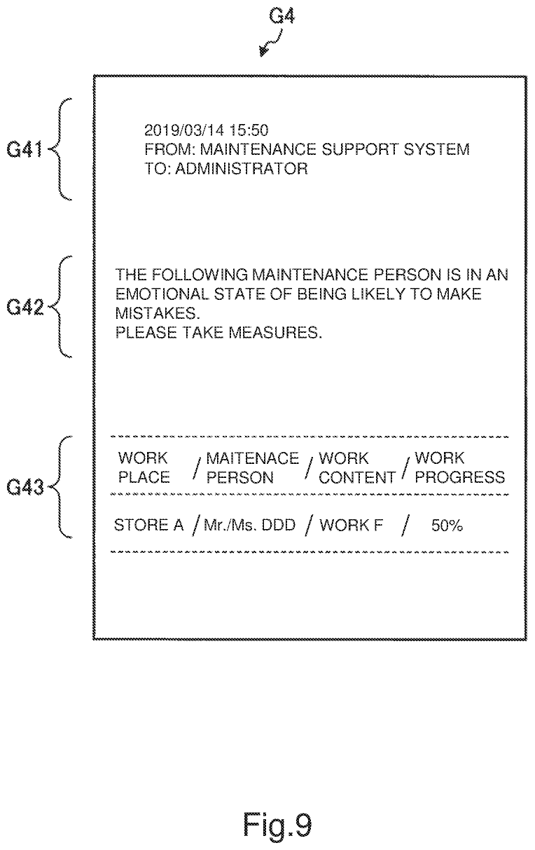

FIG. 9 is an explanatory diagram illustrating an example of the notification screen G4. The notification screen G4 is a screen notifying that the maintenance person is in an emotional state of being likely to make mistakes. The notification screen G4 includes a header area G41, a message area G42, and a maintenance person situation area G43. In the header area G41, the date and time when the notification information is received and the fact that the notification information has been transmitted from the maintenance support system 1 to the administrator. In the message area G42, a message that notifies the administrator of that the maintenance person is in a state of being likely to make mistakes is displayed. For example, in the message area G42, a massage “The following maintenance person is in an emotional state of being likely to make mistakes. Please take measures.” is displayed. In the maintenance person situation area G43, the situation of the maintenance person such as the work place, the person in charge, the work content, and the work progress is displayed.

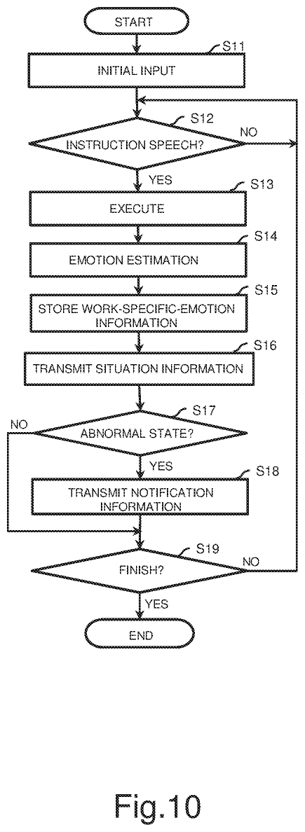

Next, state monitoring processing to be executed by the controller 101 of the maintenance person terminal 10 will be described. FIG. 10 a flowchart illustrating an example of state monitoring processing to be executed by the maintenance person terminal 10.

In Step S11, the controller 101 (instruction speech input module 1003) accepts an initial input. In more detail, the instruction speech input module 1003 receives identification information capable of identifying a maintenance person, information indicating the work place, information indicating the work content, and the like. Note that the initial input may be input in advance, input via a network, or accepted by the controller 101 (operation control module 1002).

In Step S12, the instruction speech input module 1003 determines whether or not the sound collection device 105 has accepted an input of an instruction speech that instructs an operation. In the case where the sound collection device 105 has not accepted the input of the instruction speech (Step S12; No), the instruction speech input module 1003 stands by until the instruction speech is input.

In the case where the sound collection device 105 has accepted the input of the instruction speech (Step S12; Yes), the processing of the controller 101 proceeds to Step S13. In Step S13, the controller 101 (processing execution module 1004) executes processing identified by the instruction speech.

In Step S14, the controller 101 (emotion estimation module 1005) estimates, on the basis of the input instruction speech, the emotional state of the speaker, i.e., the maintenance person.

In Step S15, the controller 101 (storage control module 1007) stores, in the storage device 102, the work-specific-emotion information 107 in which the work information indicating the work identified by the instruction speech and the emotional state estimated by the emotion estimation module 1005 are associated with each other.

In Step S16, the controller 101 (communication control module 1001) transmits, to the management server 20, situation information indicating the work situation of the maintenance person.

In Step S17, the controller 101 (notification control module 1006) determines whether or not the speaker, i.e., the maintenance person who operates the maintenance person terminal 10 by voice is in an abnormal state.

In the case where the maintenance person is determined to be in an abnormal state (Step S17; Yes), the processing of the controller 101 proceeds to Step S18. In Step S18, the controller 101 (communication control module 1001) transmits notification information to the administrator terminal 30.

In the case where it is determined that the maintenance person is not in an abnormal state (Step S117; No), the processing of the controller 101 proceeds to Step S19. In Step S19, the controller 101 (the instruction speech input module 1003) determines whether or not the sound collection device 105 has accepted an input of the instruction speech for finishing the use of the maintenance person terminal 10. In the case where the sound collection device 105 has not accepted the input of the instruction speech for finishing the use of the maintenance person terminal 10 (Step S19; No), the processing of the controller 101 returns to Step S12. Then, the controller 101 continues the state monitoring processing.

In the case where the sound collection device 105 has accepted the instruction speech for finishing the use of the maintenance person terminal 10 (Step S19; Yes), the controller 101 finishes the state monitoring processing.

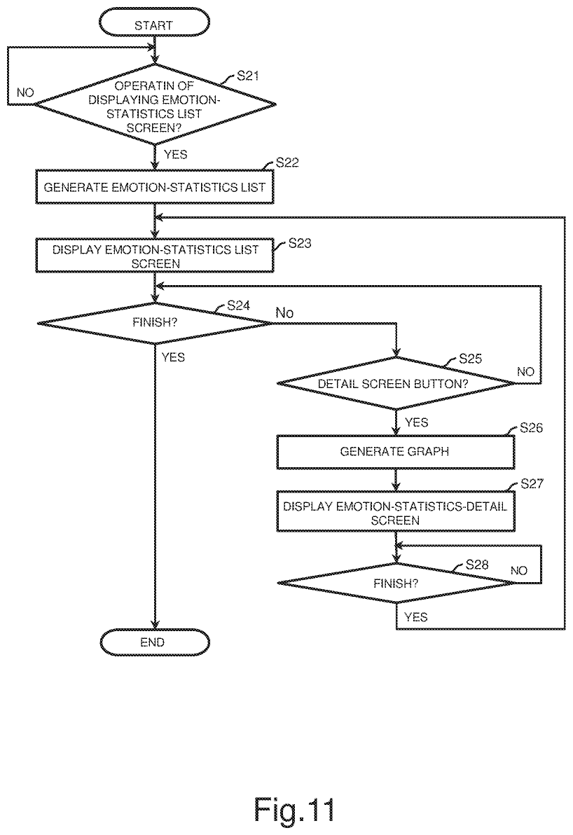

Next, statistics display processing to be executed by the maintenance person terminal 10 will be described. FIG. 11 is a flowchart illustrating an example of statistics display processing to be executed by the controller 101 of the maintenance person terminal 10.

In Step S21, the controller 101 (operation control module 1002) determines whether or not the touch panel display 104 has accepted an operation of displaying the work-specific-emotion-statistics list screen G1. In the case where the touch panel display 104 has not accepted the operation of displaying the work-specific-emotion-statistics list screen G1 (Step S21; No), the operation control module 1002 stands by until the touch panel display 104 accepts the operation of displaying the work-specific-emotion-statistics list screen G1.

In the case where the touch panel display 104 has accepted the operation of displaying the work-specific-emotion-statistics list screen G1 (Step S21; Yes), the processing of the controller 101 proceeds to Step S22. In Step S22, the controller 101 (display control module 1009) generates the work-specific-emotion-statistics list G11 on the basis of the work-specific-emotion information 107 stored in the storage device 102. In Step S23, the display control module 1009 displays, in the touch panel display 104, the work-specific-emotion-statistics list screen G1 including the work-specific-emotion-statistics list G11.

In Step S24, the operation control module 1002 determines whether or not the touch panel display 104 has accepted the operation of finishing the display of the work-specific-emotion-statistics list screen G1. In the case where the touch panel display 104 has not accepted the operation of finishing the display of the work-specific-emotion-statistics list screen G1 (Step S24; No), the processing of the controller 101 (operation control module 1002) proceeds to Step S25. In Step S25, the operation control module 1002 determines whether or not the detail screen button G12 has accepted a touch operation. In the case where the detail screen button G12 has not accepted a touch operation (Step S25; No), the processing of the controller 101 (operation control module 1002) returns to Step S24.

In the case where the detail screen button G12 has accepted a touch operation (Step S25; Yes), the processing of the controller 101 proceeds to Step S26. In Step S26, the controller 101 (display control module 1009) generates a graph of the emotion-statistics-detail screen G2 on the basis of the work-specific-emotion information 107 of the work associated with the detail screen button G12. In Step S27, the display control module 1009 displays, on the touch panel display 104, the emotion-statistics-detail screen G2 including the generated graph.

In Step S28, the controller 101 (operation control module 1002) determines whether or not the touch panel display 104 has accepted the operation of finishing the display of the emotion-statistics-detail screen G2. In the case where the touch panel display 104 has not accepted the operation of displaying the work-specific-emotion-statistics list screen G1 (Step S28; No), the controller 101 (operation control module 1002) stands by until the touch panel display 104 accepts the operation of finishing the display of the work-specific-emotion-statistics list screen G1. In the case where the touch panel display 104 has accepted the operation of finishing the display of the work-specific-emotion-statistics list screen G1 (Step S28; Yes), the processing of the controller 101 (operation control module 1002) returns to Step S23.

Further, in Step S24, in the case where the touch panel display 104 has accepted the operation of finishing the display of the work-specific-emotion-statistics list screen G1 (Step S24; Yes), the controller 101 finishes the statistics display processing.

As described above, the maintenance person terminal 10 according to the embodiment accepts an input of an instruction speech that instructs an operation. Further, the maintenance person terminal 10 uses the instruction speech to estimate the emotional state of the operator. Then, the maintenance person terminal 10 outputs the estimated emotional state. As described above, the maintenance person does not need to input a speech to the maintenance person terminal 10 for the purpose of only causing the maintenance person terminal 10 to determine the emotional state of his/her own. Therefore, it is possible to easily grasp emotions by a speech.

Further, in the above-mentioned embodiment, the maintenance person terminal 10 estimates the emotional state of the speaker who has uttered the instruction speech. However, the estimation of the emotional state may be executed by the management server 20. Specifically, the controller 201 of the management server 20 may include the emotion estimation module 1005 and the notification control module 1006. In this case, the maintenance person terminal 10 transmits, in the case where an input of an instruction speech has been accepted, the instruction speech to the management server 20. Then, the management server 20 estimates the emotional state of the speaker who has uttered the instruction speech.

Further, in the above-mentioned embodiment, the maintenance person terminal 10 stores the work-specific-emotion information 107. However, the management server 20 may store the work-specific-emotion information 107. Specifically, the controller 101 of the management server 20 may include the display control module 1009. In this case, the management server 20 may generate the work-specific-emotion-statistics list screen G1 shown in FIG. 6 and the emotion-statistics-detail screen G2 shown in FIG. 7, and display the screens G1 and G2 on the display device 204. Specifically, the maintenance person terminal 10 accepts an input of an instruction speech that instructs an operation. Further, the maintenance person terminal 10 transmits the input instruction speech to the management server 20. The management server 20 calculates the emotion value from the instruction speech. Alternatively, the management server 20 receives the emotion value from the maintenance person terminal 10. Then, the management server 20 may output the emotional state estimated from the emotion value. For example, the management server 20 may notify, on the basis of the emotional state, the administrator terminal 30 and the like on the condition that the management server 20 has determined that the speaker is in an abnormal state. Further, the management server 20 may store, in the storage device 202 or the like, the work-specific-emotion information 107 in which the work information indicating the work identified by the instruction speech and emotion information indicating the emotional state are associated with each other. Further, the management server 20 may display, on the basis of the work-specific-emotion information 107 stored in the storage device 202 or the like, the work in which the number of times that the speaker is determined to be in an abnormal state is equal to or greater than a predetermined threshold value, of the work performed by the speaker (maintenance person) on the display device 204 or the like. Note that the work performed by the speaker is the work identified by the instruction speech of the speaker.

The programs to be executed by each apparatus in the above-mentioned embodiment and modification is incorporated in a storage medium (ROM or storage unit) of the apparatus in advance and provided. However, the present technology is not limited thereto. The above-mentioned programs to be executed may be recorded in computer readable recording media such as CD-ROMs, flexible disks (FDs), CD-Rs, and digital versatile disks (DVDs) in installable format files or executable format files and provided. Further, the recording medium is not limited to a medium independent of a computer or an embedded system. Examples of the recording medium include a recording medium, which records or temporarily records a program transmitted via a LAN, the Internet, or the like and downloaded.

Further, the programs to be executed by each apparatus in the above-mentioned embodiment and modification may be stored in a computer connected to a network such as the Internet, downloaded via the network, and provided. Further, the above-mentioned programs may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an input device that accepts an input of an instruction speech for instructing an operation, the instruction speech being uttered by a speaker;
an output device that outputs an emotional state of the speaker; and
a controller that:
estimates, where the input device has accepted the instruction speech for instructing an operation uttered by the speaker, the emotional state of the speaker on a basis of the instruction speech, and
causes the output device to output the estimated emotional state.

2. The information processing apparatus according to claim 1, wherein the controller:
determines, on a basis of the estimated emotional state of the speaker, whether or not the speaker is in an abnormal state, and
causes, where the speaker is determined to be in the abnormal state, the output device to output notification information indicating that the speaker is in the abnormal state.

3. The information processing apparatus according to claim 1, wherein
the controller accepts, via the input device, an input of identification information capable of identifying the speaker, information indicating a work place of the speaker, and information indicating work content of the speaker, and
the notification information includes the identification information capable of identifying the speaker, the information indicating a work place of the speaker, and the information indicating work content of the speaker.

4. The information processing apparatus according to claim 1, further comprising:
a storage device that stores emotion information indicating the emotional state of the speaker, wherein
the controller stores work-specific-emotion information in the storage device, work information and the emotion information being associated with each other in the work-specific-emotion information, the work information indicating work identified by the instruction speech.

5. The information processing apparatus according to claim 4, wherein the controller stores the work-specific-emotion information in the storage device every time the input device accepts an input of the instruction speech uttered by the speaker.

6. The information processing apparatus according to claim 4, further comprising:
a display device that displays information indicating statistics of a state of the speaker, wherein
the controller displays, on the display device, work in which the number of times that the speaker is determined to be in the abnormal state is equal to or greater than a threshold value, of the work identified by the instruction speech uttered by the speaker, on a basis of the work-specific-emotion information stored in the storage device.

7. The information processing apparatus according to claim 6, wherein the controller displays, on the display device, the statistics of the state of the speaker in a plurality of levels in accordance with the number of times of the abnormal state of the speaker.

8. The information processing apparatus according to claim 6, wherein the controller:
displays, on the display device, the statistics of the speaker for each of pieces of content of the work identified by the instruction speech uttered by the speaker and a detail screen button for switching a screen of the display device in association with the corresponding content of the work, and
displays, where the detail screen button is operated, a transition of an emotion value on the display device, the emotion value indicating the emotional state of the speaker in the content of the work associated with the operated detail screen button.

9. An information processing method for an information processing apparatus, the method comprising:
accepting an input of an instruction speech for instructing the information processing apparatus to perform an operation, the instruction speech being uttered by a speaker;
estimating an emotional state of the speaker on a basis of the accepted instruction speech; and
outputting the estimated emotional state.

10. A speech emotion recognition system, comprising:
an input device that accepts an input of an instruction speech for instructing an operation, the instruction speech being uttered by a speaker;
an output device that outputs an emotional state of the speaker; and
a controller that:
estimates, where the input device has accepted the instruction speech for instructing an operation uttered by the speaker, the emotional state of the speaker on a basis of the instruction speech, and
causes the output device to output the estimated emotional state.
